(19) United States
(12) Patent Application Publication
(10) Pub. No.: US 2006/0132323 A1
(43) Pub. Date: Jun. 22, 2006

(54) Strobe beacon

(75) Inventor: James A. Grady JR., Elko, NV (US)

Correspondence Address: THORPE NORTH & WESTERN, LLP., 8180 SOUTH 700 EAST, SUITE 200, SANDY, UT, 84070, US

(73) Assignee: Milex Technologies, Inc.

(21) Appl. No.: 11/236,058

(22) Filed: Sep. 26, 2005

Related U.S. Application Data
(60) Provisional application No. 60/613,681, filed on Sep. 27, 2004.

(51) Int. Cl. G09F 9/33; G08B 5/00; G08B 1/00; G08B 21/00; G08B 23/00; B64D 47/00

(52) U.S. Cl. 340/815.45; 340/331; 340/983; 340/643; 340/693.3; 340/531

(57) ABSTRACT

A strobe beacon light includes a base with a light-transmissive cover, and a plurality of LEDs, supported upon the base and within the cover and oriented to provide light in at least three directions through the cover. A power supply is attached to the base, and provides power for operation of the LEDs. Control circuitry is operably interconnected to the LEDs and the power source, and includes a flash controller, configured to selectively actuate the LEDs in any of a plurality of flashing sequences, and a power monitor, configured to automatically monitor the power supply.

### CROSS-REFERENCE TO RELATED APPLICATIONS AND CLAIM OF PRIORITY

Priority of U.S. Provisional patent application Ser. No. 60/613,681 filed on Sep. 27, 2004 is claimed.

### FIELD OF THE INVENTION

The present invention relates generally to strobe beacons. More particularly, the present invention relates to an LED strobe beacon that has a high light output, and is selectively reprogrammable to provide multiple illumination sequences.

### BACKGROUND

Strobe beacons or strobe lights are commonly used to provide a visual indication of danger or some condition requiring caution in a particular area, and to alert users to operating conditions or malfunctions of equipment. For example, strobe beacons may be used to advise personnel in manufacturing facilities when an operation or machine is in operation, or is starting or stopping, or to warn personnel that they are entering a dangerous or restricted area. Strobes can be mounted on vehicles or stationary equipment to warn other drivers or pedestrians of their presence or operation. They can be permanently or temporarily placed to indicate the presence of dangerous or hazardous locations or conditions, like highway construction barricades, ocean buoys, mine shafts, etc.

Strobe beacons are also frequently used in conjunction with warning signs or indicators. For example, highway signs indicating school zones, tight curves, or upcoming signal lights, and highway barricades delineating construction zones, frequently combine textual or non-textual warning signs with flashing lights to attract attention. Essentially any type of warning sign can be used in conjunction with flashing lights. Strobe beacons can also be used as indicators.

There are a variety of types of strobe beacons that have been developed and used. These provide various advantages and disadvantages. Traditionally, xenon flash tube strobes and rotating halogen beacons have been the most common. However, these types of strobes present a number of disadvantages. They are relatively power hungry, requiring a significant amount of current for operation and tend to have poor vibration tolerance, inflexible designs, and a relatively short life span (typically on the order of months). These old technologies are often referred to as commodity items or “cheap, throwaway strobes,” and cost users a tremendous amount of money in replacement parts, maintenance time, cost of capital from multiple SKU's in a warehouse, and equipment downtime. They can even lead to compromises in safety due to unreliable performance.

### SUMMARY OF THE INVENTION

It has been recognized that it would be desirable to provide a strobe beacon that provides high intensity light, and yet has a long useful life, low power draw, is durable, operationally flexible, and reliable.

The invention advantageously provides a strobe beacon light, including a base, a light-transmissive cover, attached to the base, and a plurality of LEDs, supported upon the base and within the cover, oriented to provide light in at least three directions through the cover. A power supply is attached to the base, and provides power for operation of the LEDs. Control circuitry is operably interconnected to the LEDs and the power source, and includes a flash controller, configured to selectively automatically actuate the LEDs in any of a plurality of flashing sequences, and a power monitor, configured to automatically monitor the power supply.

In accordance with another more detailed aspect thereof, the invention provides a strobe beacon light that detects ambient light conditions, and automatically adjust its light output accordingly.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front perspective view of one embodiment of a daylight strobe beacon constructed in accordance with the present invention.

FIG. 2 is a top view of the strobe of FIG. 1.

FIG. 3 is a front perspective view of the strobe of FIG. 1 with the cover removed.

FIG. 4 is a front perspective view of the strobe of FIG. 1 with the cover and capture plate removed.

FIG. 5 is a rear perspective view of the strobe of FIG. 1 with the cover and capture plate removed.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As noted above, xenon flash tube strobes and rotating halogen beacons are outdated, expensive technology. By incorporating newer LED technology, the present invention provides an improved warning light that includes a high intensity strobe with a long useful life, low power consumption, high durability, and operational flexibility. It can be used in daytime or nighttime situations, in heat or cold, rain or shine.

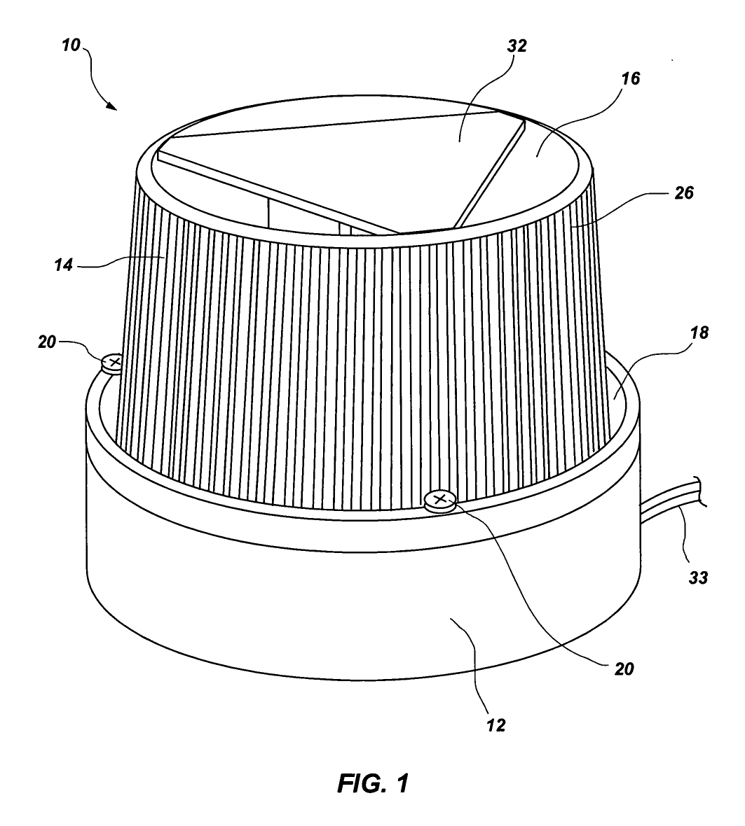

Various views of one embodiment of a strobe beacon 10 in accordance with the present invention are shown in FIGS. 1-5. Viewing FIG. 1, the strobe beacon generally comprises a base 12, with a cover 14 (also referred to as a lens or bezel), attached thereto. The device can be made very compact. In one embodiment, the strobe is 5.25 inches in diameter by 4.5 inches high. The base may be made of a UV stabilized fiberglass nylon composite material, which is tough and will provide years of durable protection for the electronics and other internal components. The base can be configured for direct mounting (e.g. with fasteners that attach the base to another structure), or with a magnetic base, or for mounting to a pipe. This mounting flexibility allows attachment to a wide variety of supports, such as a motor vehicle, a warning sign, an equipment cabinet, a structural support (e.g. a portion of a building, scaffold, railing, mine tunnel shoring, etc.), etc. For vehicle mounting, a lighter plug cord (not shown) can be provided for connecting the strobe to the vehicle's power system.

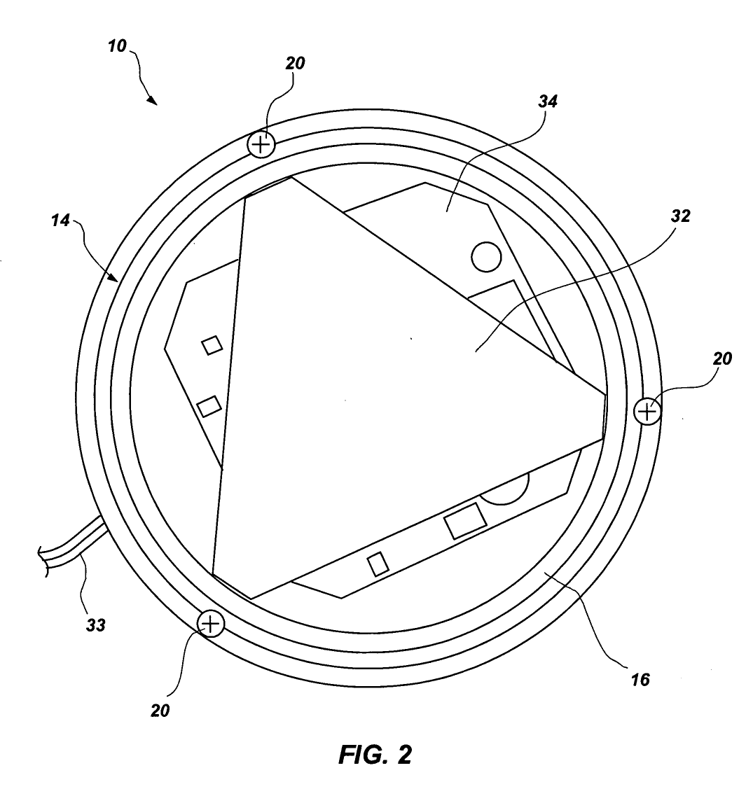

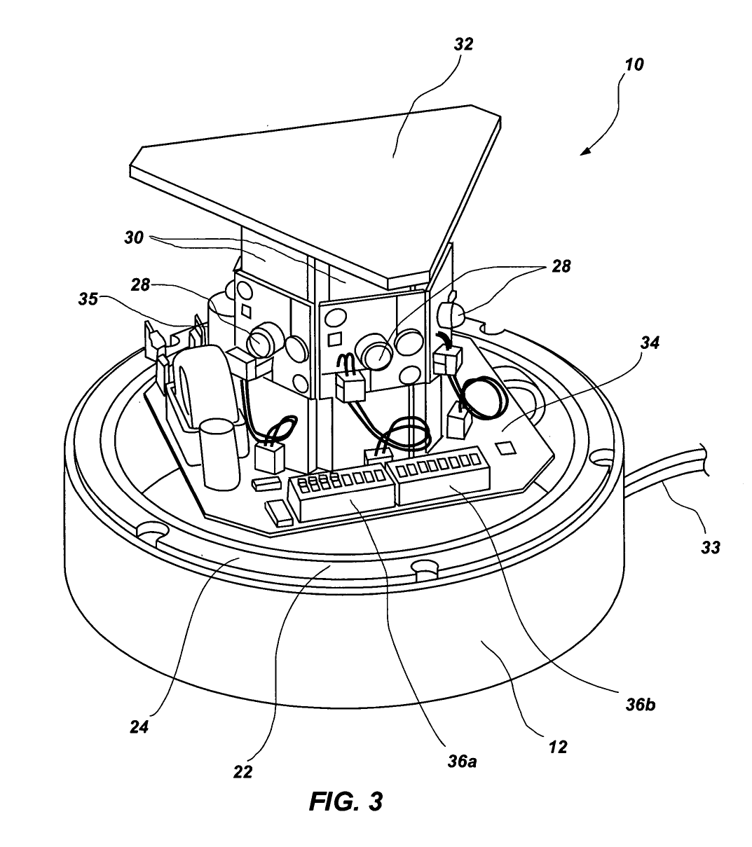

As shown in the FIGS. 1 and 2, the cover 14 includes a top panel 16 and a lower flange 18 configured for attachment to the base 12 via screws 20 or other fasteners. Viewing FIG. 3, a rubber o-ring 22 is disposed in a groove 24 around the base, so as to press against the lower flange of the cover when the cover is connected, to provide a watertight seal. As shown in the figures, the cover has a generally cylindrical shape, but it will be apparent that other shapes can also be used. The cover can be made of an impact-resistant, transparent plastic material. One suitable material is a shatter-resistant acrylic such as Lucite® by DuPont. Another suitable material is polycarbonate, such as Lexan®. The cover can also be made using polymethyl methacrylate, and polyethylene terephthalate. The transparent plastic material can be formed having a substantial thickness. For example, in one embodiment the plastic material can have a thickness of at least ¼ inch.

The combination of the material of the housing and its cylindrical shape helps give the strobe great strength and durability. The high level of strength can allow the strobe beacon to be used in physically hazardous areas, heavy industry, and so forth. Typical hazards present in industries such as mining and road construction can include falling rocks, vibrations caused by the use of heavy equipment, a large amount of traffic, and frequent movement. Such hazards can rapidly decrease the average lifetime of other lighting products. The sturdy cover formed from transparent plastic having a substantial thickness can greatly reduce the risk of damaging the electronics located inside the cover.

The cover or bezel 14 has light-transmissive properties. In other words, it is at least partially transparent, so as to transmit light from within. The cover can also include features that serve to modify the characteristics of transmitted light. For example, referring back to FIG. 1, the surface (e.g. the inner surface) of the cover can include deformations, such as ridges 26 or dimples, or be otherwise treated to cause it to diffuse or diffract the light that is transmitted therefrom. In one embodiment, the ridges can be configured to form a Fresnel lens. Other treatments to modify the light can also be made. For example, the cover could be colored so as to color the light that is transmitted. Ordinarily, however, it is desirable that the cover be made of a clear material, so that the color of the projected light is not determined by the cover, but by the color of the light emitted from the LEDs.

The configuration of the base 12 and cover 14 give it excellent durability and resistance to rust and corrosion. The strobe is water resistant, and is configured to withstand some of the most abusive operating conditions and environments. Furthermore, in addition to providing terrific shock and impact tolerance, the clear cover enhances the color rendering of the LEDs. Colored light generated directly by LEDs allows the color of the light to be better distinguished at a distance. The clear appearance when not illuminated may also be an advantage in complying with local regulations regarding amber, red, or blue strobes on public roadways when the strobe is turned off. This provides true color clarity throughout the viewing distance of the strobe, as opposed to the often white glare found with xenon strobes.

As shown in FIGS. 3-5, within the cover 14 and attached to the base 12 are a plurality of high intensity LEDs 28. The LEDs are supported upon substantially vertical supports 30 attached to the base, and are oriented to provide light in multiple directions through the cover. In accordance with the embodiment shown in the figures, the base has a mounting orientation, and the LEDs are disposed upon a mounting board. The mounting board can be comprised of supports, which extend upward from the base, in such as way as to orient the LEDs in a direction substantially perpendicular to the mounting orientation of the base. Advantageously, the LEDs are radially outwardly oriented, and can even be substantially symmetrically oriented, so that the LEDs essentially fall at regular points around a circle, giving full 360° high intensity illumination about a plane. The LEDs can provide illumination orthogonal to the plane at a predetermined angle. For example, in one embodiment the LEDs can illuminate a horizontal 360 degree plane at vertical angle between ±12 and ±20 degrees. In order to provide illumination about the horizontal plane, the strobe includes at least three LEDs, each illuminating 120 degrees of the horizontal plane. However, other quantities can be used. For example, the strobe as shown in FIGS. 3-5 includes 6 LEDs disposed in an approximate circle.

The LEDs 28 have an intensity sufficient for clear visibility in daylight conditions. The LEDs are preferably high intensity light-emitting diodes having a light output of at least 8000 millicandela (mcd), though LEDs with other characteristics can be used. The high intensity LEDs flash brightly to provide a low-current, high attention-getting device visible at up to one mile.

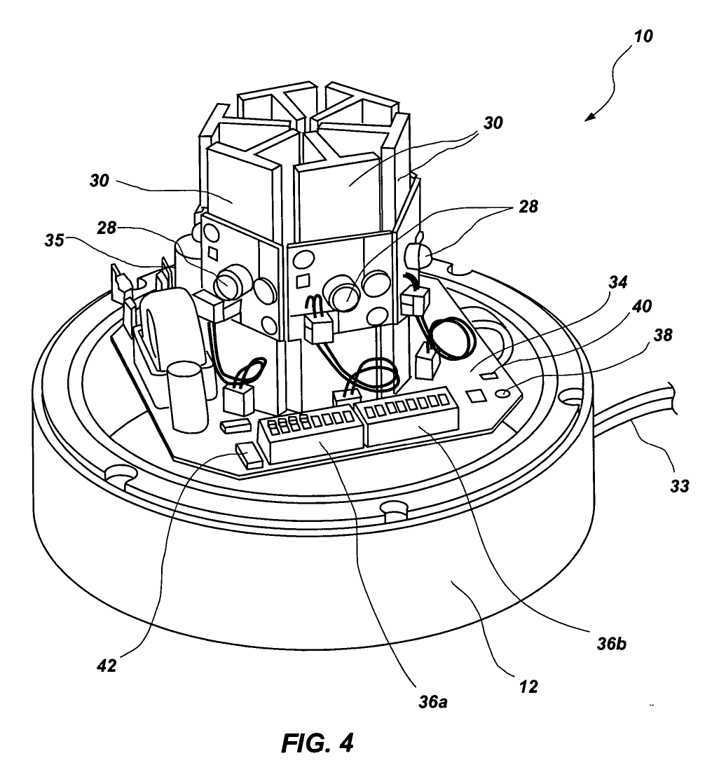

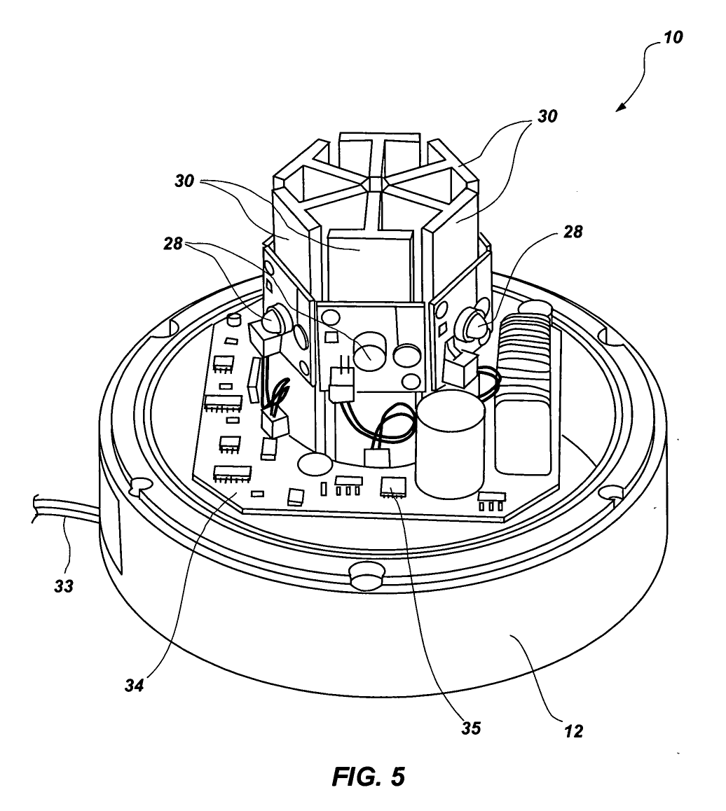

In the embodiment shown in the figures, each of the plurality of LEDs 28 are mounted on an independent support 30, such as an aluminum T-section, as seen in FIGS. 4-5. The supports extend vertically from a connection point in the base 12 to just under the top panel 16 of the cover, and help provide vertical structural integrity. The top ends of the supports are interconnected by a capture plate 32, which helps provide continuous vertical structural integrity, lateral stability and shock absorption to stabilize the light sources (LEDs) against vibration. The capture plate can be made of a resilient material, such as urethane plastic. Advantageously, the supports can also be configured to operate as heat sinks, to dissipate heat from the LEDs. The aluminum shapes in the hexagonal arrangement provide effective heat dissipation to prevent overheating of the strobe. It will be apparent that different shapes and arrangements of heat dissipating devices can also be used.

A power supply (not shown) can be attached to the base 12 via a power cord 33 or directly coupled to the base. The power supply is configured to provide power for operation of the LEDs 28, as described in more detail below. A controller microprocessor 35, disposed on a controller circuit board 34, is operably interconnected to the LEDs and the power source, and controls the operation of the LEDs and other features of the device. The controller includes a flash controller, configured to selectively automatically actuate the LEDs 28 in any of a plurality of flashing sequences. Disposed on the controller circuit board are two groups of eight (8) micro switches or dip switches 36a, 36b. These switches allow a user to select any one of the plurality of flashing sequences, and to control other functions of the strobe. Advantageously, the flash pattern may be selected and changed throughout the life of the strobe by simply removing the three screws 20 and the cover 14, and changing the positions of dip switches. The strobe 10 is thus completely programmable, allowing the user to switch back and forth between all combinations of flash patterns and light sensor modes. This and other features make this strobe a very operationally flexible and mobile equipment strobe.

In one embodiment, the strobe 10 comes with 8 pre-set flash patterns. These can be a single repeating flash, a double repeating flash, a triple repeating flash, a quadruple repeating flash, a combination of fast and slow flashes, a sequential flash of the LEDs to simulate a rotating beacon, and a combination of the simulated rotating beacon together with the combination of fast and slow flashes. Other flash sequences can be provided as well. Indeed, given the number of 16 dip switches, a total of 65,536 flash patterns could be programmed into the device. For example, a particular user could request custom flash patterns and power levels, which could be custom programmed into the flash controller at the factory for given switch settings. It will be apparent that where all possible switch settings are not needed to correspond to specific flash pattern settings, some switch settings may have no effect or be unrecognized by the controller. In such case, the control circuitry can be configured to flash an error code if the switches are placed in an unrecognized configuration.

While various flash patterns can be used to disseminate warnings and information to people, the LEDs can be flashed, or modulated, at a much higher rate to transmit data. The amount of data that can be transmitted on a carrier wave is a function of the frequency of the carrier. Due to the extremely high frequency of light waves, visible and infrared LEDs can be used to transmit large amounts of data. Visible LEDs include LEDs configured to produce electromagnetic radiation at a wavelength that produces light having a color of white, blue, red, amber, green, and a combination of these colors. Data can be modulated onto the light waves at a rate of several thousand bits (kilobits) per second to several million bits per second (megabits). The human eye typically can't see changes in luminosity which occur faster than 60 cycles per second. For example, most incandescent light bulbs are powered with AC power alternating at 60 cycles per second. Thus, data can be transmitted at high rates, using the LEDs to communicate with external sensors, without affecting the visible attributes of the LED light.

Before a signal carrying information can be transmitted, the information signal is typically converted to a sinusoidal waveform using bandpass modulation. Bandpass modulation can be either digital or analog. For digital modulation, a sinusoid of duration T is referred to as a digital symbol. The sinusoid has three features that can be used to distinguish it from other sinusoids: amplitude, frequency, and phase. Thus, the bandpass modulation can be defined as the process whereby the amplitude, frequency, or phase of a carrier signal (or a combination of them) can be varied in accordance with the information to be transmitted.

The strobe beacon 10 can be configured to modulate data using bandpass modulation onto the light emitted by one or more of the LEDs. A modulator and/or demodulator may be included within the microprocessor controller 35. Alternatively, a separate modulation and/or demodulation circuit may be added to the controller circuit board 34. The circuit(s) are configured to enable the LEDs and optical receivers to be used to send and receive data. In one embodiment, one or more infrared LEDs may be included within the strobe beacon and used to transmit data. Optical receivers configured to receive modulated data can be located either internally within the strobe beacon, or external to the beacon. An optical receiver, such as a photodiode circuit, can enable two way communications using the strobe beacon.

Modulating data onto the electromagnetic energy emitted by the strobe beacon can be useful in a number of situations. For example, a service or security vehicle having a strobe beacon can transmit a security clearance code using the beacon. The vehicle can gain access to a secure area such as a government building, a police or fire building, or a secure work site such as a mine or building site. Further information can be transmitted including operational status of a vehicle, contents of the vehicle, weight of the vehicle, a time of day the vehicle has arrived at a location, an identity of occupants of the vehicle, information about the occupants, an operational status of the high intensity LED strobe beacon, information about a direction of travel of the vehicle, or any other type of information desired by a user.

Networks, such as a Control Area Network, can be established at industrial areas and mines. The networks can include a number of receivers and transmitters configured to communicate with each strobe beacon 10. The strobe beacons can be used to communicate with both man and machine. For example, in noisy industrial areas hearing protection is often worn. Great care must be taken by workers to avoid moving machinery that they may not be able to hear. A strobe beacon flashing in a predetermined manner can inform the workers that a vehicle is backing up. Data transmitted by the strobe beacon can inform nearby sensors, such as lights, that the vehicle is backing up. In a mining operation, data can be transmitted by the beacon to lights mounted on mine walls that a vehicle is backing up to enable miners to avoid collisions. Identification codes on each vehicle throughout the mine or other industrial worksite can be transmitted by the beacon to the network to allow managers to know the location of each vehicle. The mechanical status of each vehicle can also be transmitted to the network, allowing managers to know when a vehicle needs to be refueled or repaired.

Each strobe light can also be controlled from a central location using the control area network. The network may be based on optical or radio frequency control. Transmitters located throughout the industrial area can be used to send data to the strobe beacons. The strobe beacons may be located on vehicles, along escape paths, at entrances, and so forth. The strobe beacons can be used to keep the workers informed. In one embodiment, the strobe beacons can have a predetermined flash sequence to inform workers of an accident or dangerous situation. The optical warning using the strobe beacons can allow workers in noisy areas, or workers using hearing protection equipment, to be informed of dangerous conditions. This can improve the response time of the workers and help to save lives.

As noted above, the strobe beacon 10 is configured to be attached to a power supply (not shown). The power supply can be any electric AC or DC power source (preferably DC), such as a chemical battery, a motor vehicle power source, a stationary equipment power source, and a facility power source (e.g. a building electrical system, with proper transformers to provide DC power). The strobe is configured to operate on DC power in the range of 12 to 30 volts. However, the device can be configured to operate on a higher voltage range with minor modifications.

Advantageously, by using energy-efficient LEDs 28 and operating them in a pulsed manner, the strobe consumes a relatively small amount of power. In one embodiment produced by the inventor, the LED strobe consumes 0.1 to 1 amps (½ amp average) at 12 volts DC for the above-described flash patterns. Power is only consumed when the LEDs are lit. By comparison, conventional, comparably intense strobes typically have a current draw of 2-8 amps at 12 volts. It will be apparent that the actual power consumption rate is flash pattern-dependent, and that flash patterns that consume more power can be devised and used. Nevertheless, with the flash patterns programmed by the inventor, a typical motor vehicle electrical system can power the strobe for days longer than prior xenon or halogen strobes, without the worry of dead batteries.

The microprocessor controller 35 advantageously includes a power monitor or battery monitor system, configured to automatically monitor the power supply. This is a user-selectable system, actuated and configured by specific settings of the dip switches 36. When activated, this system automatically provides a low power fault indication to the user via the LEDs when a power output parameter of the power source drops below a threshold level. For example, the power monitor can be configured to monitor voltage, and provide the fault indication when the voltage drops to some level below the standard operating voltage (e.g. twelve (12) volts). In one embodiment, the strobe 10 switches to a warning flash pattern when the power source voltage decreases to 111.8 v. The power monitor can also send a signal to the microprocessor which can reduce power from the power supply to the LEDs or shut off power to the LEDS. The power monitor can be configured to then automatically reset when the power output returns to a normal range.

The fault indication for the power monitor could be any selected visual indication, such as a repeating sequence of two rapid flashes of the LEDs, followed by two slow flashes of the LEDs. Alternatively, the fault indication could include flashing an alternating left and right rotating flash pattern. Whatever fault indication pattern is selected, it is desirable that the fault indication flash pattern draw as little current as reasonably possible, so as to minimize the drain on the equipment batteries.

As noted above, LEDs inherently consume less power than prior xenon and halogen strobes. The strobe beacon 10 of the present invention is further configured for greater energy efficiency. For example, the controller 35, via the dip switches 36, can be selectively configured to actuate the LEDs 28 only at certain times, such as only during the night, or at a reduced power level permanently or at certain specified times. The reduced power level can be about one half full power, or some other reduced power level, allowing a great power savings. When the reduced power operation is activated, the LEDs will be more dimly illuminated, thus saving power.

The strobe device 10 also includes other advantageous features that increase its usefulness and longevity. For example, the controller circuits can include reverse polarity and short circuit protection, so that if the device is cross wired to its power source or short circuited, the strobe will simply not function, rather than allowing circuits to burn out. Once the fault condition is corrected, the strobe will automatically resume normal operation. This protection is unlike most prior xenon flash tube strobes, which can explode under a short circuit condition.

For additional energy efficiency, the strobe beacon 10 can also include a photo sensor 38, interconnected with the controller 35. The photo sensor is configured to sense ambient light conditions surrounding the strobe light, and provide this information to the controller to allow automatic adjustment of operation of the strobe light. Actuation and use of the photo sensor is a user selectable feature that is actuated via the dip switches 36a, 36b. In one configuration, when the photo sensor is engaged, the strobe will automatically decrease its light output intensity/power level under darker conditions. As noted above the reduced power level can be approximately one half full power. In another configuration, the photo sensor will cause the strobe to shut off during the day, and run only at night.

The strobe beacon 10 can also include a temperature sensor 40, configured to sense ambient temperature conditions within the cover 14. The controller 35 receives signals from the temperature sensor, and can cause the strobe light to flash an error code or other indication when the temperature exceeds a threshold, signaling a user to move the strobe light to a cooler location. The high temperature error code can be a slow single flash pattern, for example. This feature provides overheat protection for the device. As with many LED technologies, this strobe beacon is designed to operate under relatively severe cold or hot environments. The device has a relatively low operating temperature and low circuitry voltage, making it one of the safest strobes to operate. However, when the temperature of the strobe reaches excessive levels (e.g. above about 175° F.), it can be damaging to continue to operate it. The controller can also reduce power to the LEDs or substantially eliminate power to the LEDs above a certain threshold temperature. Thus the high temperature warning system contributes to the longevity and safety of the device. On the other hand, both xenon flash tubes and halogen lamps present significant shock and/or explosion hazards.

The controller 35 can also include digital memory 42 that allows it to retain a record of various operational parameters over a time period of use. This information can be helpful for repair and warranty purposes. For example, the memory can record operating data such as temperature, voltage, ambient light, and flash patterns, for future download. This information can be augmented by a time stamp from the controller that allows the operational parameters to be correlated to other events or conditions. The memory can be configured as flash memory, so that the data is retained in case of power loss. This information allows a repair technician to help troubleshoot the device, and also determine whether warranty conditions have been exceeded. The digital memory may also be used to store data that is transmitted to and/or received from external sources.

The present invention advantageously provides a durable strobe beacon with daylight intensity, long life, high intensity, low power draw, great durability, operational flexibility, and many other desirable features. It provides multiple, selectable flash patterns. The illumination color is selectable (e.g. amber, red, blue, white or green light). The inventor estimates a design life of over 50,000 hours, which equates to over 5 years of continuous use. Older technologies, in contrast, often burn out in months. Advantageously, the device does not produce radio or laser interference. Unlike xenon flash tubes, LED's do not introduce interference into communication radio, CB radio, or cellular phone transmissions. Additionally, laser leveling equipment is not affected by this device, making it highly useful and safer at construction sites, mining operations, and other locations where radio communications and lasers are commonly used. The device also includes other desirable features, such as reverse polarity protection, short circuit protection, photocell-controlled day/night operation, user-selectable power levels from 0.2 to 1 amp at 12 volts DC. The device also has very high vibration and impact tolerance. The solid state design with no moving parts or filaments results in a strobe that can take substantial abuse without failure.

The invention thus provides a powerhouse strobe beacon in a relatively small package. The invention is useful for a wide variety of applications, including industrial sites, federal, state and municipal agencies, homeland security, warehousing, law enforcement agencies, railroad applications, industrial plants, towing fleets, construction, timber, military, departments of transportation, petrochemical, trucking, airline ground support, telecommunications, refineries, utilities, commercial fleets, oil exploration, mining, and many more.

By way of example, and without limitation, the invention can be described as providing a strobe beacon light, comprising a base, a cover, attached to the base, having light-transmissive properties, a plurality of LEDs, supported upon the base and within the cover, oriented to provide light in at least three directions through the cover, a power supply, attached to the base, configured to provide power for operation of the LEDs, and control circuitry, operably interconnected to the LEDs and the power source, including (i) a flash controller, configured to selectively automatically actuate the LEDs in any of a plurality of flashing sequences, and (ii) a power monitor, configured to automatically monitor the power supply.

It is to be understood that the above-referenced arrangements are only illustrative of the application of the principles of the present invention. Numerous modifications and alternative arrangements can be devised without departing from the scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A high intensity LED strobe beacon, comprising:
a mounting base;
a mounting board coupled to the mounting base;
a plurality of high intensity LEDs electrically coupled to the mounting board;
a cover configured to protect the plurality of LEDs, wherein the cover is light transmissive, has a substantially cylindrical shape and is configured to be affixed to the mounting base;
a power supply configured to supply power to the plurality of high intensity LEDs; and
a power monitor configured to monitor a level of power available from the power supply to operate the plurality of high intensity LEDs at a predetermined voltage.

2. The high intensity LED strobe beacon of claim 1, further comprising a temperature sensor configured to monitor a temperature within the cover.

3. The high intensity LED strobe beacon of claim 2, wherein the temperature sensor is configured to trigger a warning alert when a temperature within the cover exceeds a predetermined temperature.

4. The high intensity LED strobe beacon of claim 3, wherein the warning alert is selected from the group consisting of a predetermined flashing pattern in the plurality of high intensity LEDs, a message transmitted using radio frequency communications, a message transmitted using optical communications, a reduced power level to the plurality of LEDs, and a substantial elimination of power to the LEDs.

5. The high intensity LED strobe beacon of claim 1, wherein the mounting board is a flexible mounting board configured to absorb vibrations in the high intensity LED strobe beacon to provide protection to the plurality high intensity LEDs.

6. The high intensity LED strobe beacon of claim 1, wherein the cover is comprised of a substantially clear plastic material.

7. The high intensity LED strobe beacon of claim 6, wherein the substantially clear plastic material is comprised of a material selected from the group consisting of Lexan, Lucite, polycarbonate, polymethyl methacrylate, and polyethylene terephthalate.

8. The high intensity LED strobe beacon of claim 1, further comprising a microprocessor operably interconnected to the LEDs and the power source, wherein the microprocessor is configured to control operation of the LEDs.

9. The high intensity LED strobe beacon of claim 8, wherein the microprocessor further comprises a flash controller, configured to selectively actuate the LEDs in a plurality of different flashing sequences.

10. The high intensity LED strobe beacon of claim 8, further comprising a plurality of switches electronically coupled to the microprocessor, the switches configured to enable a user to selectively control operation of the high intensity LED strobe beacon, wherein the operation is selected from the group consisting of controlling a plurality of flashing sequences, controlling operation of a power level indicator, controlling operation of a photo sensor, and controlling data transmission.

11. The high intensity LED strobe beacon of claim 8, further comprising a temperature sensor configured to sense ambient temperature conditions within the cover.

12. The high intensity LED strobe beacon of claim 11, wherein the temperature sensor is configured to send a signal to the microprocessor to enable a change in power sent to the high intensity LEDs, wherein the change in power is selected from the group consisting of a reduction of power to the high intensity LEDs, a substantial elimination of power to the LEDs, and a predetermined flashing sequence for the LEDs to provide an error code or other indication when the temperature exceeds a threshold.

13. The high intensity LED strobe beacon of claim 8, wherein the power monitor is configured to send a signal to the microprocessor to enable a change in power sent to the high intensity LEDs, wherein the change in power is selected from the group consisting of a reduction of power to the high intensity LEDs, a substantial elimination of power to the LEDs, and a predetermined flashing sequence for the LEDs to provide an error code or other indication when the voltage is less than a predetermined threshold.

14. The high intensity LED strobe beacon of claim 8, further comprising a photo sensor configured to send a signal to the microprocessor when external ambient light levels are below a threshold level to enable a change in power sent to the high intensity LEDs, wherein the change in power enables the high intensity LEDs to produce a reduced level of light output with respect to the LEDs operated at full power.

15. The high intensity LED strobe beacon of claim 8, further comprising a digital memory operatively coupled to the microprocessor, wherein the digital memory is configured to record operational parameters of the high intensity strobe beacon.

16. The high intensity LED strobe beacon of claim 15, wherein the operational parameters recorded by the digital memory are selected from the group consisting of ambient temperature within the cover, voltage of the power supply, ambient light levels, and a flash sequence of the plurality of LEDs.

17. The high intensity LED strobe beacon of claim 1, wherein the plurality of high intensity LEDs are oriented about the mounting board to provide light about a 360 degree plane.

18. The high intensity LED strobe beacon of claim 17, wherein the plurality of high intensity LEDs are configured to provide light in a direction orthogonal to the 360 degree plane at an angle greater than ±12 degrees relative to the plane.

19. The high intensity LED strobe beacon of claim 1, wherein the plurality of high intensity LEDs are mounted to at least two supports that extend vertically from a connection point in the base, with a top end of the supports interconnected by a capture plate configured to provide structural integrity and shock absorption to the LEDs.

20. The high intensity LED strobe beacon of claim 1, further comprising a modulator operatively coupled to at least one of the plurality of high intensity LEDs, wherein the modulator is configured to modulate data onto the high intensity LED using bandpass modulation.

21. The high intensity LED strobe beacon of claim 20, wherein the at least one of the plurality of high intensity LEDs on which data is modulated is configured to produce electromagnetic radiation of a color selected from the group consisting of infrared, substantially white, blue, red, amber, green, and a combination of red, green, and blue.

22. The high intensity LED strobe beacon of claim 20, wherein the data modulated onto the at least one high intensity LED is configured to be received by a control area network.

23. The high intensity LED strobe beacon of claim 20, wherein data modulated onto the at least one high intensity LED can comprise information selected from the group consisting of a security clearance code, identification of a vehicle, operational status of the vehicle, mechanical status of the vehicle, contents of the vehicle, weight of the vehicle, a time of day the vehicle has arrived at a location, an identity of occupants of the vehicle, information about the occupants, an operational status of the high intensity LED strobe beacon, information about a direction of travel of the vehicle.

24. A high intensity LED strobe beacon configured to sense ambient light levels, comprising:
a mounting base;
a mounting board coupled to the mounting base;
a plurality of high intensity LEDs electrically coupled to the mounting board;
a cover configured to protect the plurality of LEDs, wherein the cover is light transmissive, has a substantially cylindrical shape and is configured to connect to the mounting base;
a microprocessor operably interconnected to the LEDs and the power source, wherein the microprocessor is configured to control operation of the LEDs; and
a photo sensor configured to send a signal to the microprocessor when ambient light levels are below a threshold level to enable a change in power sent to the high intensity LEDs, wherein the change in power enables the high intensity LEDs to produce a reduced level of light output with respect to the LEDs operated at full power.

25. A high intensity LED strobe beacon configured for transmitting data, comprising:
a mounting base;
a mounting board coupled to the mounting base;
a plurality of high intensity LEDs electrically coupled to the mounting board;
a cover configured to protect the plurality of LEDs, wherein the cover is light transmissive, has a substantially cylindrical shape and is configured to connect to the mounting base;
a microprocessor operably interconnected to the LEDs and the power source, wherein the microprocessor is configured to control operation of the LEDs; and
a modulator operatively coupled to at least one of the plurality of high intensity LEDs, wherein the modulator is configured to modulate data onto the at least one high intensity LED using bandpass modulation.

26. The high intensity LED strobe beacon of claim 25, wherein the at least one of the plurality of high intensity LEDs on which data is modulated is configured to produce electromagnetic radiation of a color selected from the group consisting of infrared, substantially white, blue, red, amber, green, and a combination of red, green, and blue.

27. The high intensity LED strobe beacon of claim 25, wherein the data modulated onto the at least one high intensity LED is configured to be received by a control area network.

28. The high intensity LED strobe beacon of claim 25, wherein data modulated onto the at least one high intensity LED can comprise information selected from the group consisting of a security clearance code, identification of a vehicle, operational status of the vehicle, mechanical status of the vehicle, contents of the vehicle, weight of the vehicle, a time of day the vehicle has arrived at a location, an identity of occupants of the vehicle, information about the occupants, an operational status of the high intensity LED strobe beacon, information about a direction of travel of the vehicle.
